(19) United States
(12) Patent Application Publication
(10) Pub. No.: US 2023/0018293 A1
(43) Pub. Date: Jan. 19, 2023

(54) RETAIL DISPLAY UNIT WITH SWING DOOR

(71) Applicant: Target Brands, Inc., Minneapolis, MN (US)

(72) Inventors: Scott E. Denby, Minneapolis, MN (US); Jennifer A. Theisen, Crystal, MN (US); Andrew J. Liesveld, Omaha, NE (US)

(21) Appl. No.: 17/375,260

(22) Filed: Jul. 14, 2021

(51) Int. Cl. A47F 3/00; E05B 65/00; E05C 7/04; E05D 7/04

(52) U.S. Cl. CPC A47F 3/004; A47F 3/005; A47F 3/002; E05B 65/0025; E05C 7/04; E05D 7/0423; E05D 2007/0469; E05Y 2900/202

(57) ABSTRACT

A retail display unit includes a top, a base including a slot and at least one swing door. The at least one swing door is rotatably coupled to the top and the base and includes a main panel and a lower rail engaged with a bottom of the main panel. A door catch is mounted to a back side of the lower rail and has a channel opening that faces downwardly at the base. A latch is rotatable through the slot in the base. When the at least one swing door is in a closed position, the latch is rotated through the slot in the base and positioned in the channel opening of the door catch to lock the at least one swing door.

### BACKGROUND

Retail display units or display cabinets may have doors that are made of transparent panels in order to visually display items, such as merchandise, that are stored in the display unit. For purposes of security, being able to lock the doors that have transparent panels without obstructing the visual display of the items is desirable.

The discussion above is merely provided for general background information and is not intended to be used as an aid in determining the scope of the claimed subject matter. The claimed subject matter is not limited to implementations that solve any or all disadvantages noted in the background.

### SUMMARY

A retail display unit includes a top, a base having a slot and at least one swing door rotatably coupled to the top and the base and including a main panel and a lower rail engaged with a bottom of the main panel. A door catch is mounted to a back side of the lower rail and has a channel opening that faces downwardly at the base. A latch is rotatable through the slot in the base. When the at least one swing door is in a closed position, the latch is rotated through the slot in the base and positioned in the channel opening of the door catch to lock the at least one swing door.

A retail display unit comprising a top, a base, a back wall and right-handed and left-handed side panels. The base includes a slot. At least one swing door is rotatably coupled to the top and the base and has a main panel and a lower rail engaged with a bottom of the main panel. A lower door catch is coupled to a back side of the lower rail and has a channel opening that faces downwardly at the base. A lock includes a lock body and a rotatable latch. The lock body includes a key hole configured to receive a key. When the at least one swing door is in a closed position, the lock body is activated by the key to rotate the latch through the slot in the base and into the channel opening of the lower door catch.

A retail display unit includes at least one swing door that is rotatably coupled to a top and a base of the retail display unit and is configurable into a closed position. The swing door includes a main panel and a lower rail engaged with a bottom of the main panel. A lower door catch is mounted to a back side of the lower rail and has a channel opening that faces downwardly at the base. A latch is rotatable through a slot in the base and positioned into the channel opening of the lower door catch to configure the at least one swing door into a locked position.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a top right perspective view of a retail display unit according to an embodiment.

FIG. 2 illustrates the retail display unit of FIG. 1 with right-handed and left-handed swing doors in an opened position.

FIG. 3 is a front view of FIG. 1.

FIG. 4 is a right side view of FIG. 1, the left side view being a mirror image.

FIG. 5 is a top view of FIG. 1.

FIG. 6 is a top left perspective view of the retail display unit of FIG. 1 with gondola components of the retail display unit removed.

FIG. 7 is an exploded view of FIG. 6.

FIG. 8 is an enlarged perspective view of a portion of a top of FIG. 6 with a right-handed access panel removed.

FIG. 9 is a back perspective view of FIG. 8.

FIG. 10 is an enlarged cutaway view of an adjustment mechanism coupled to a right-handed upper hinge of a right-handed swing door.

FIG. 11 is an enlarged top perspective view of a left-handed lower hinge of a left-handed swing door with portions shown in phantom for purposes of illustration.

FIG. 12 is an enlarged bottom perspective view of the left-handed lower hinge of the left-handed swing door with portions shown in phantom for purposes of illustration.

FIG. 13 illustrates a front bottom perspective view of a base deck of FIG. 6.

FIG. 14 illustrates a back bottom perspective view of the base deck of FIG. 6 with lock hardware removed.

FIG. 15 illustrates a back perspective view of a left-handed swing door of FIG. 6.

FIG. 16 illustrates an exploded view of FIG. 15.

FIG. 17 illustrates a section view taken through the section lines indicated in FIG. 15.

FIG. 18 illustrates a back perspective view of a right-handed swing door of FIG. 6.

FIG. 19 illustrates an exploded view of FIG. 18.

FIG. 20 illustrates a section view taken through the section lines indicated in FIG. 18.

FIGS. 21-23 illustrate enlarged top perspective views of operation of a lock with exemplary left-handed swing door as the lock changes from an unlocked position to a locked position.

FIG. 24 illustrates an enlarged top perspective view of the lock with the exemplary right-handed swing door in a locked position.

### DETAILED DESCRIPTION

Swinging doors that have transparent panels may be framed or frameless. Framed transparent doors have their transparent panels framed by framing material, such as wood or the like. Framed transparent doors are compatible with conventional lock and hinge hardware, however, the frame material causes a portion of the swinging door not to be transparent and partially blocks items, such as merchandise, being displayed or stored in a retail display unit. Frameless transparent doors do not have the visual obstruction that a framed transparent door has, but is unable to use conventional lock and hinge hardware. Described below is a retail display unit having frameless transparent swing doors with adjustable hinges and an unobtrusive lock.

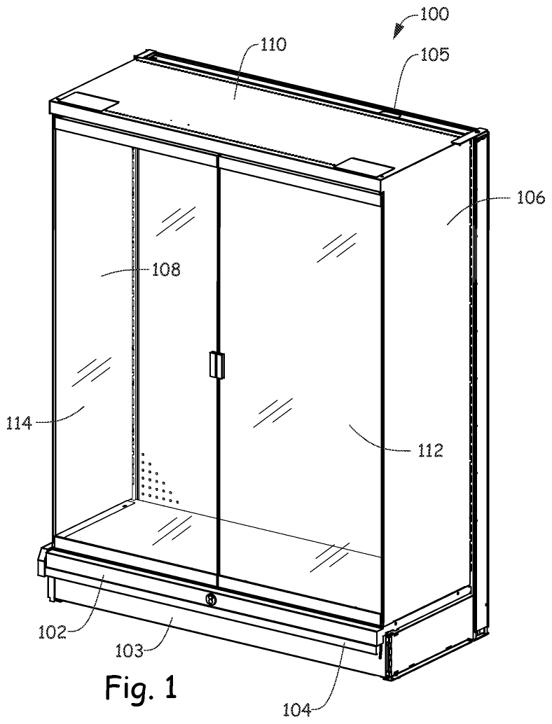

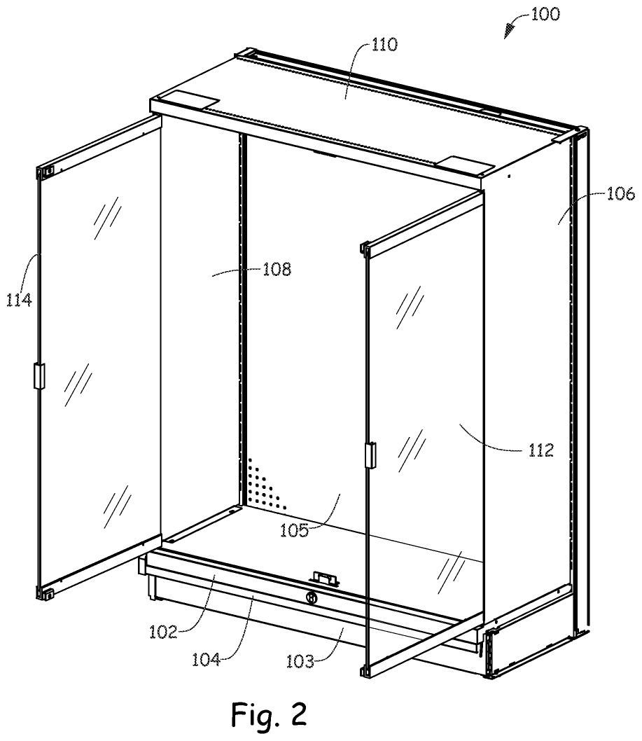

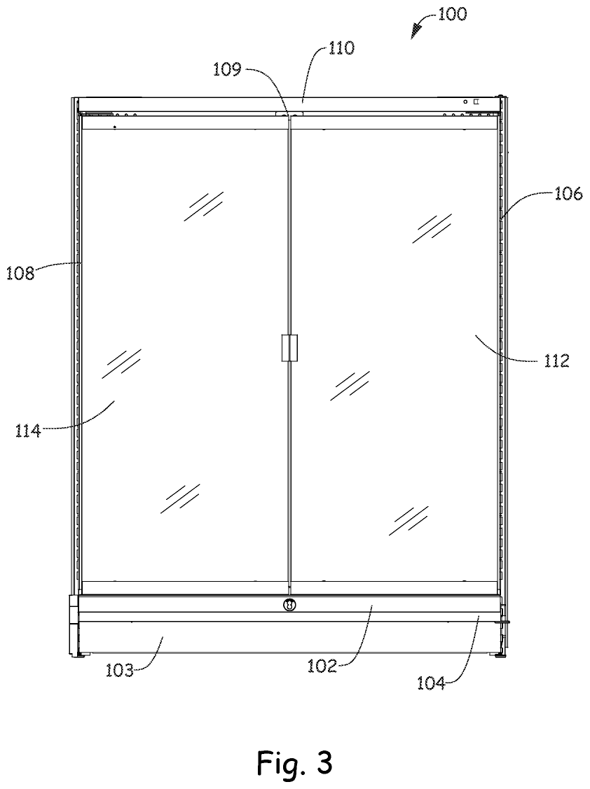

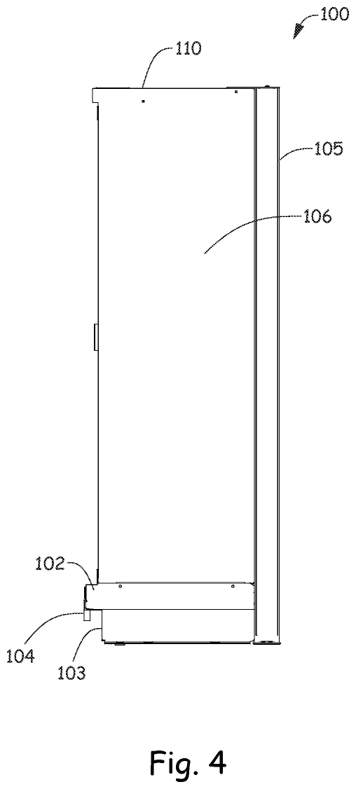

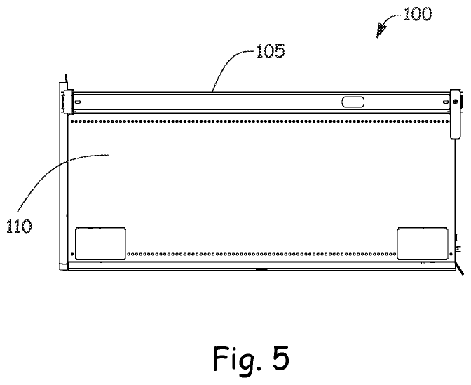

FIG. 1 illustrates a top right perspective view of a retail display unit 100 according to an embodiment. FIG. 2 illustrates retail display unit 100 with right-handed and left-handed swing doors in an opened position. FIG. 3 is a front view of retail display unit 100, FIG. 4 is a right side view of retail display unit 100 (the left side view being a mirror image) and FIG. 5 is a top view of retail display unit 100. Retail display unit 100 includes a base or base deck 102, a toe kick 103, a bumper 104, a back wall 105, a right-handed end panel 106, a left-handed end panel 108, a top or top shelf 110 and at least one swing door. In the illustrated embodiments, retail display unit 100 includes a right-handed swing door 112 and a left-handed swing door 114. Back wall 105 extends between left-handed and right-handed uprights 116 and 117. Base 102 and top 110 are both mounted to uprights 116 and 117 and right-handed swing door 112 and left-handed swing door 114 are rotatably coupled to base 102 and top 110 by upper and lower hinges. Right-handed and left-handed swing doors 112 and 114 includes main panels 111 and 115 that are made of a transparent material so as to display the merchandise being displayed inside retail display unit 100.

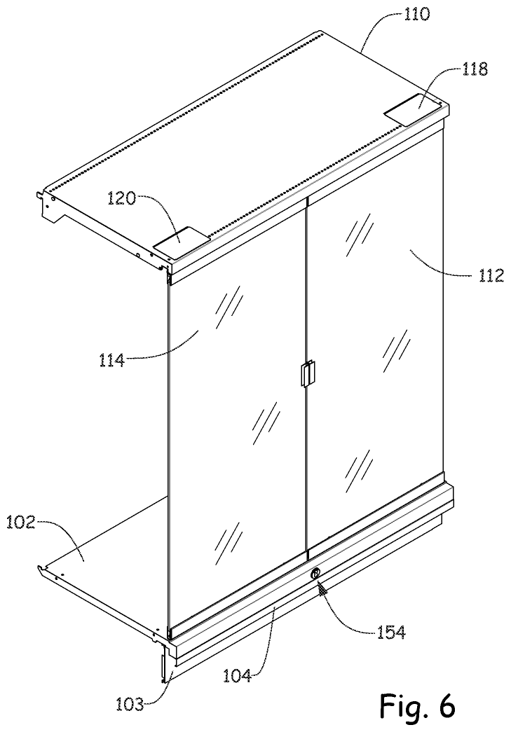

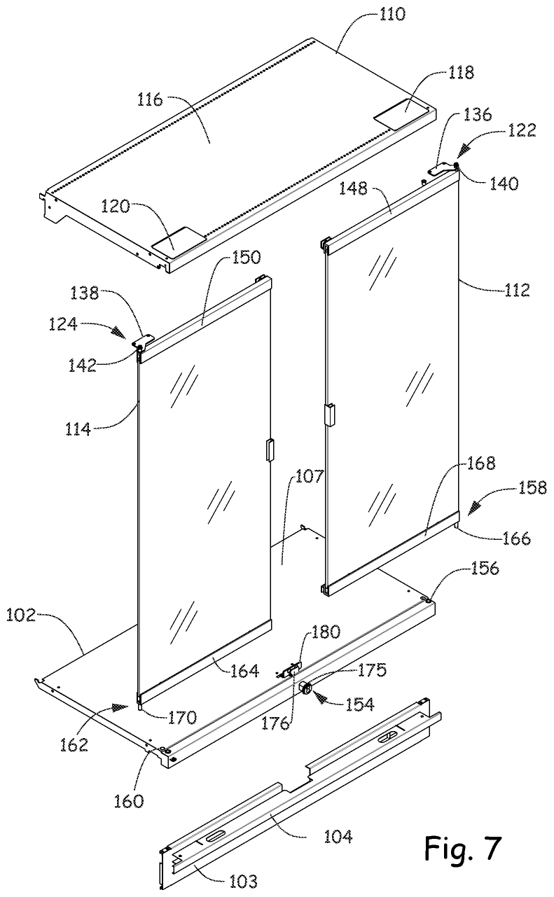

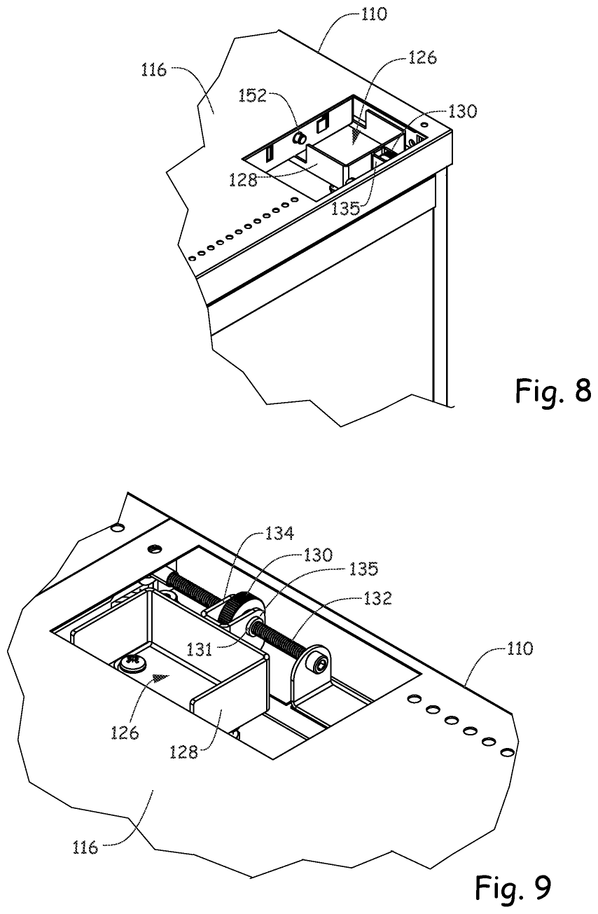

FIG. 6 is a top left perspective view of retail display unit 100 with gondola components of retail display unit 100 removed. In FIG. 6, back wall 105, right-handed end panel 106 and left-handed end panel 108 are removed. FIG. 7 is an exploded view of FIG. 6. As illustrated in FIGS. 6 and 7, top 110 includes a top surface 116, a right-handed access panel 118 and a left-handed access panel 120. Right-handed access panel 118 is removable from top 110 to access a right-handed upper hinge 122 (FIG. 7) of right-handed swing door 112 and a corresponding right-handed adjustment mechanism 126 (FIGS. 8-10). Left-handed access panel 120 is removable from top 110 to access a left-handed upper hinge 124 of left-handed swing door 114 and a corresponding left-handed adjustment mechanism (not shown). Right-handed adjustment mechanism 126 is configured to level right-handed swing door 112 and the left-handed adjustment mechanism is configured to level left-handed swing door 114.

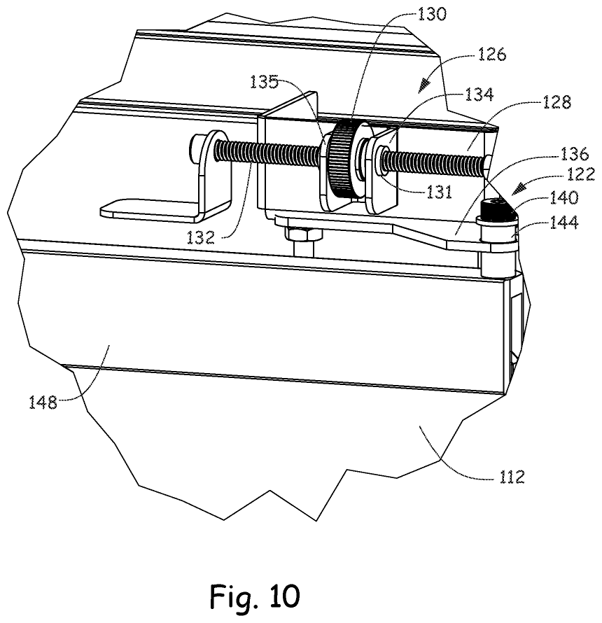

FIG. 8 is an enlarged perspective view of a portion of top 110 with right-handed access panel 118 removed. FIG. 9 is a back perspective view of FIG. 8. FIG. 10 is an enlarged cutaway view of right-handed adjustment mechanism 126 coupled to right-handed upper hinge 122. It should be realized that a left-handed adjustment mechanism is coupled to left-handed upper hinge 124 and mirrors the look and functionality of right-handed adjustment mechanism 126. Adjustment mechanism 126 includes an adjustment bracket 128, an adjustment knob 130 and a head screw 132. Adjustment bracket 128 includes a pair of flanges 134 and 135 that capture adjustment knob 130, bearings 131 and head screw 132. In the embodiment illustrated in FIGS. 8-10, adjustment knob 130 is a thumb nut.

Each of right-handed and left-handed upper hinges 122 and 124 include respective right-handed and left-handed shoulder screws 140 and 142 each having a head, a shoulder and a thread. The shoulder of each shoulder screw 140 and 142 functions as rotatable dowels inside respective sleeves or bushings 144 (the left-handed bushing is not specifically pointed out) to rotate each swing door 112 and 114 about an axis. The thread of each shoulder screw 140 and 142 couples respective bushings 144 and respective mounting brackets 136 and 138 to respective upper rails 148 and 150 of each swing door 112 and 114.

As illustrated in FIG. 10, adjustment bracket 128 is coupled, for example by a bolt, to mounting bracket 136. To level right-handed swing door 112, adjustment knob 130, upon actuation, is spun backwardly or forwardly to move knob 130 side-to-side along head screw 132. Adjustment bracket 128 being coupled to adjustment knob 130 and upper hinge 122 also moves side-to-side to level right-handed swing door 112. It should be realized that a left-handed adjustment mechanism (not specifically shown) operates in the same way to level left-handed swing door 114. Top surface 116 of top 110 is securely held in place by snap buttons 152. A right-handed snap button 152 is accessible through right-handed access panel 118 and a left-handed snap button (not illustrated) is similar to right-handed snap button 152 and is accessible through left-handed access panel 120.

With reference back to FIGS. 6 and 7, a lock 154 is mounted to base 102 and base 102 includes a right-handed aperture 156 configured to receive a right-handed lower hinge 158 and a left-handed aperture 160 configured to receive a left-handed lower hinge 162. Right-handed lower hinge 158 includes a pin or dowel 166 that is attached to and protrudes downwardly from a lower rail 168 of right-handed swing door 112. Pin or dowel 166 is received by a bushing and right-handed opening 156 in base deck 102 and is captured by a set screw on a bottom side of base deck 102.

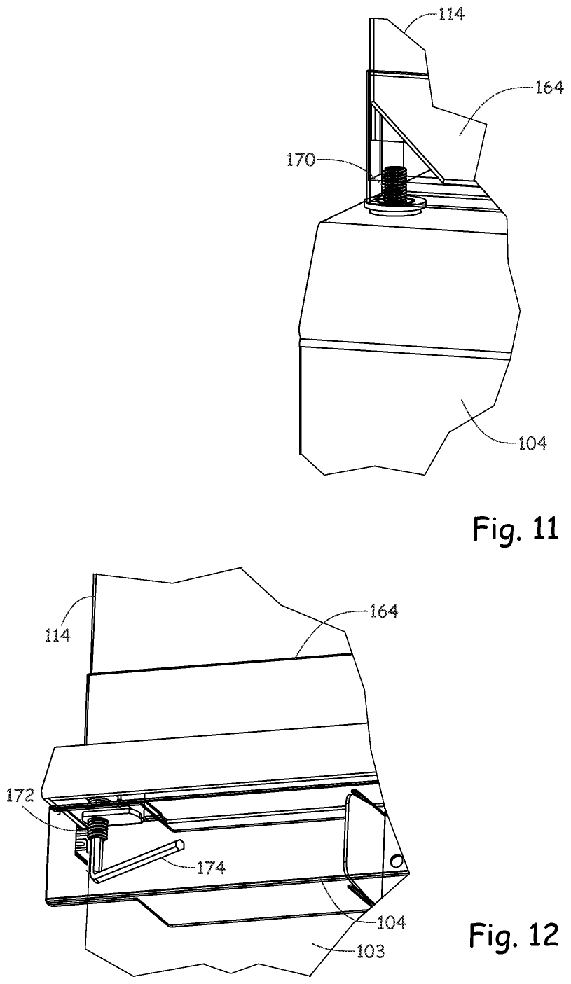

FIG. 11 is an enlarged top perspective view of left-handed lower hinge 162 of left-handed swing door 114. A front of lower rail 164 of left-handed swing door 114 is shown in phantom for purposes of illustrating lower hinge 162. FIG. 12 is an enlarged bottom perspective view of left-handed lower hinge 162 of left-handed swing door 114. Bumper 104 is shown in phantom for purposes of illustration. It should be realized that right-handed lower hinge 158 of right-handed swing door 112 mirrors the look and functionality of left-handed lower hinge 162 of left-handed swing door 114. Left-handed lower hinge 162 includes a pin or dowel 170 that is attached to and protrudes downwardly from a lower rail 164 of left-handed swing door 114. Pin or dowel 170 is received by a bushing and left-handed aperture 160 in base 102 and is captured by a set screw 172 on a bottom side of base 102. Set screw 172 can be tightened or loosened by wrench 174. As illustrated in FIG. 11, set screw 172 extends inside dowel or pin 170.

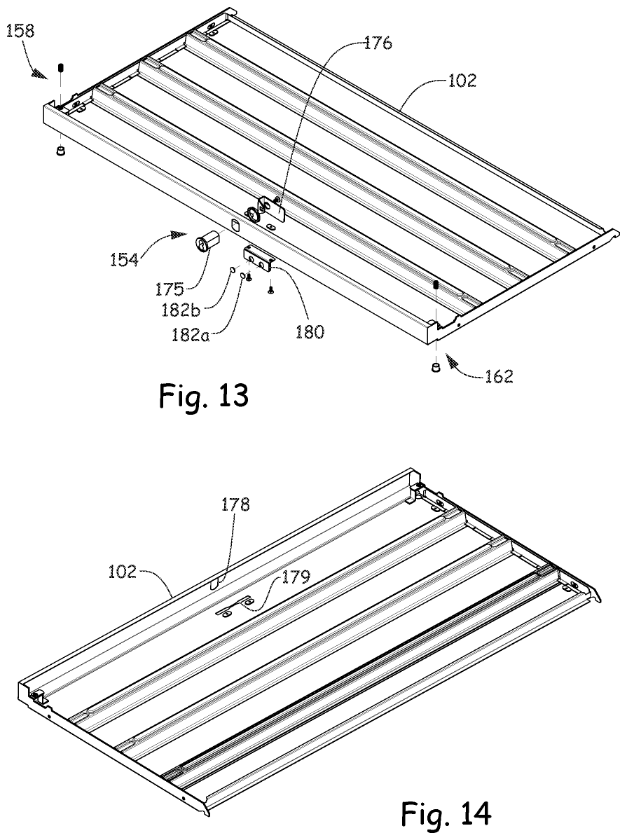

FIG. 13 illustrates a front bottom perspective view of base 102. FIG. 14 illustrates a back bottom perspective view of base 102 with the hardware of lock 154 removed. In FIG. 13, right-handed and left-handed set screws and bushings of right-handed and left-handed lower hinges 158 and 162 are illustrated. In addition, lock 154 is illustrated exploded from base 102. Lock 154 includes a lock body 175 and a latch 176. Lock body 175 includes a keyhole 177 configured to receive a key. By turning a corresponding key in keyhole 177, latch 176 rotates 90 degrees from the unlocked position illustrated in FIG. 13 to a locked position. The assembled lock 154 illustrated in FIG. 7 shows latch 176 rotated into a locked position. In FIG. 14, base 102 includes an aperture 178 configured to receive lock body 175 and a slot 179 through which latch 176 moves through when rotated from the unlocked position to the locked position or from the locked position to the unlocked position. FIG. 13 further illustrates a lower door stop 180 that is mounted to and protrudes upwardly from a top surface 107 of base 102. Lower door stop 180 includes one or more magnets, for example, a pair of magnets 182a and 182b.

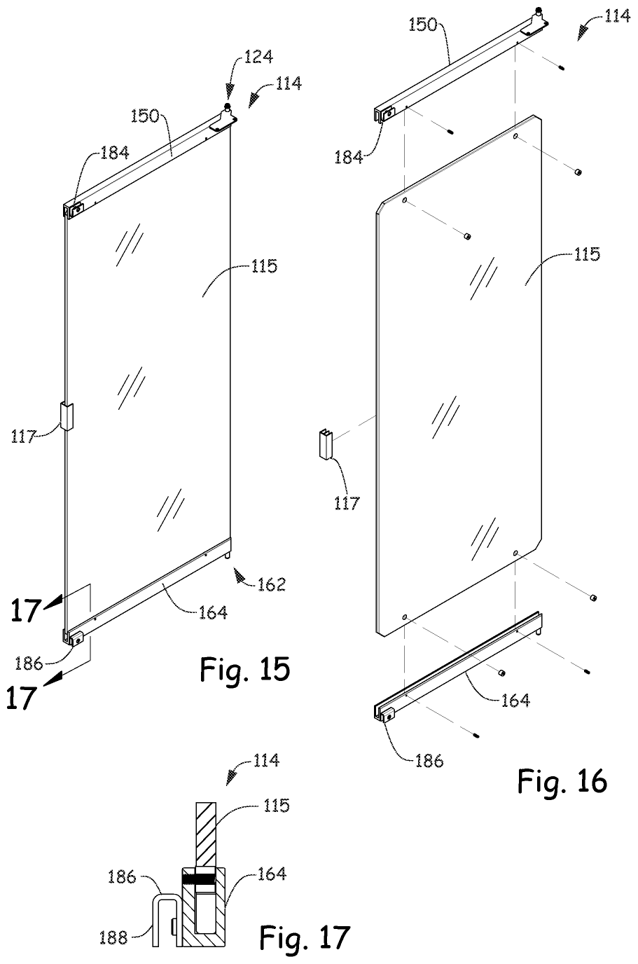

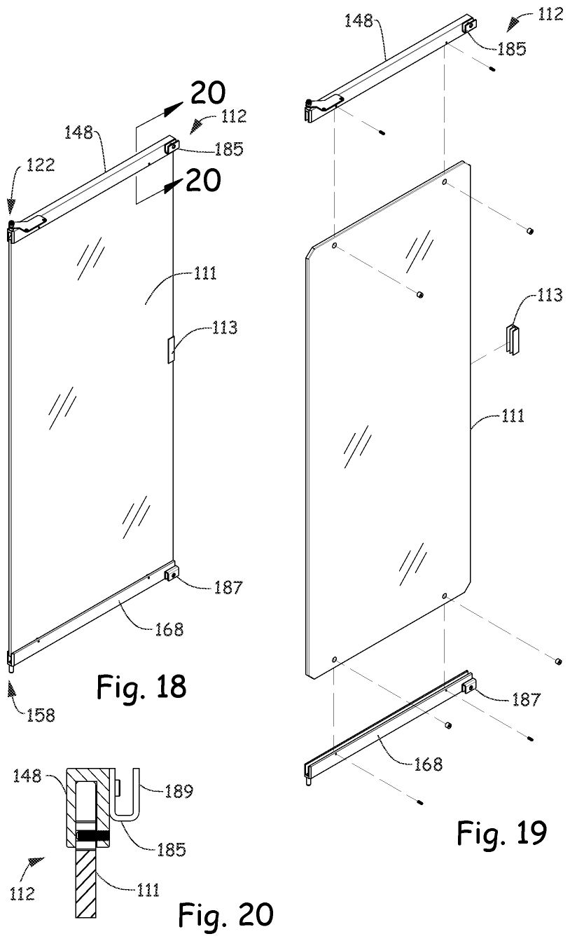

FIG. 15 illustrates a back perspective view of left-handed swing door 114. FIG. 16 illustrates an exploded view of FIG. 15. FIG. 17 illustrates a section view taken through the section lines indicated in FIG. 15. FIG. 18 illustrates a back perspective view of right-handed swing door 112. FIG. 19 illustrates an exploded view of FIG. 18. FIG. 20 illustrates a section view taken through the section lines indicated in Left-handed swing door 114 includes transparent main panel 115, upper rail 150, lower rail 164 and a handle 117. Right-handed swing door 112 includes transparent main panel 111, upper rail 148, lower rail 168 and handle 113. In one embodiment, transparent main panels 111 and 115 are made of glass and upper rails 148 and 150, lower rails 164 and 168 and handles 113 and 117 are made of a metallic material, such as aluminum. Upper rail 150 of left-handed swing door 114 engages with a top of main panel 115 and lower rail 164 of left-handed swing door 114 engages with a bottom of main panel 115. Upper rail 148 of right-handed swing door 112 engages with a top of main panel 111 and lower rail 168 of right-handed swing door 112 engages with a bottom of main panel 111. Left-handed upper hinge 124 is coupled to upper rail 150 of left-handed swing door 114 and left-handed lower hinge 162 is coupled to lower rail 164 of left-handed swing door 114. In addition, right-handed upper hinge 122 is coupled to upper rail 148 of right-handed swing door 112 and right-handed lower hinge 162 is coupled to lower rail 168 of right-handed swing door 112.

Upper door catches 184 and 185 are mounted to back sides of each of upper rails 148 and 150, respectively, and lower door catches 186 and 187 are mounted to back sides of each of lower rails 164 and 168, respectively. Upper door catches 184 and 185 are each configured to magnetically couple to an upper door stop 109 (see FIG. 3) that has one or more magnets, for example, a pair of magnets. Upper door stop 109 protrudes downwardly from a bottom of top shelf 110. A backward facing surface of upper door catch 184 of left-handed swing door 114 magnetically couples to a left side of upper door stop 109 via a left-handed magnet and a backward facing surface 189 of upper door catch 185 of right-handed swing door 112 magnetically couples a right side of upper door stop 109 via a right-handed magnet when left-handed swing door 114 and right-handed swing door 112 are in closed positions.

Lower door catches 186 and 187 are each configured to magnetically couple lower door stop 180 (see FIGS. 7 and 13). A backward facing surface 188 of lower door catch 186 of left-handed swing door 114 magnetically couples to a left side of lower door stop 180 via left-handed magnet 182a and a backward facing surface of lower door catch 187 of right-handed swing door 112 magnetically couples to a right side of lower door stop 180 via right-handed magnet 182b when left-handed swing door 114 and right-handed swing door 112 are in closed positions.

As illustrated in FIGS. 17 and 20, upper door catches 184 and 185 and lower door catches 186 and 187 are U-shaped. FIG. 17 illustrates example lower door catch 186 of left-handed swing door 114, which is similar to lower door catch 187 of right-handed swing door 112 and FIG. 20 illustrates example upper door catch 185 of right-handed swing door 112, which is similar to upper door catch 184 of left-handed swing door 114. Lower door catches 186 and 187 are oriented with their U-shaped openings or channel openings facing downwardly at base 102, while upper door catches 184 and 185 are oriented with their U-shaped openings or channel openings acing upwardly. As illustrated in FIGS. 17 and 20, U-shaped upper and lower door catches 184, 185, 186 and 187 include first legs that are attached to upper and lower rails 148, 150, 164 and 168 and second legs having backward facing surfaces. For example, lower door catch 186 includes backward facing surface 188 and upper door catch 185 includes backward facing surface 189. These backward facing surfaces (such as surfaces 188 and 189) are the surfaces that magnetically engage with upper and lower door stops 109 and 180.

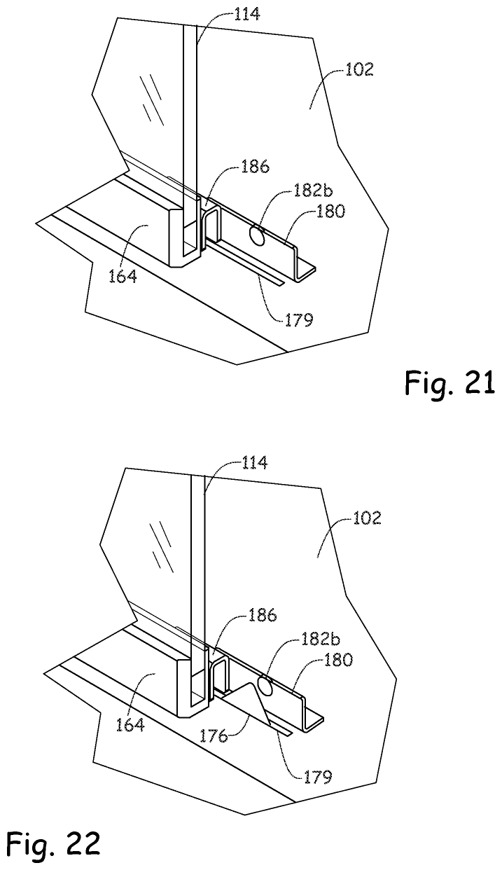

Lower door catches 186 and 187 provide additional functionality besides their engagement with lower door stop 180. When left-handed swing door 114 and right-handed swing door 112 are in closed positions, lock body 175 of lock 154 is configurable to rotate latch 176 into a locked position where latch 176 is rotated about its axis to move through slot 179 and inside the channel opening of lower door catches 186 and 187. When left-handed swing door 114 is in a closed position, lock body 175 of lock 154 may rotate latch 176 into a locked position where latch 176 moves through slot 179 and protrudes inside the channel opening of lower door catch 186. FIGS. 21-23 illustrate an enlarged top perspective views of operation of lock 154 with left-handed swing door 114 as lock 154 moves from being in an unlocked position to a locked position.

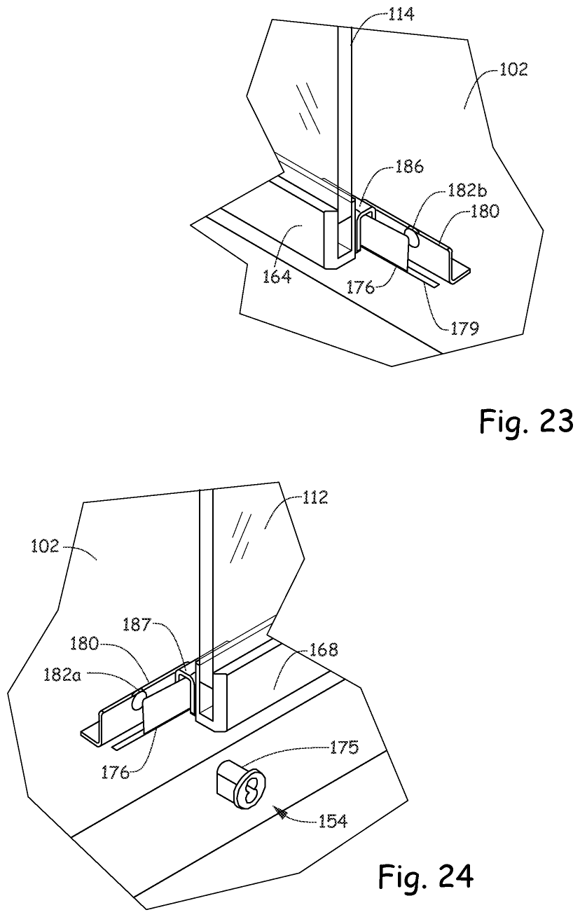

In FIG. 21, lock 154 (not illustrated) is in an unlocked position, left-handed door 114 is in a closed position and right-handed swing door 112 is in an opened position for purposes of illustration. As illustrated, lower door catch 186 coupled to the back side of lower rail 164 is magnetically engaged with lower door stop 180. However, magnet 182b is free and therefore lower catch 187 (not illustrated) is not magnetically engaged with lower door stop 180 and right-handed swing door 112 (not illustrated) is in an opened position. In FIG. 22, lock 154 is in process of being locked. As illustrated, latch 176 is rotatably moving through slot 179. In FIG. 23, lock 154 is in a locked position. As illustrated, latch 176 has been rotated 90 degrees and is located inside the channel opening of U-shaped lower door catch 186. In FIG. 23, left-handed swing door 114 is not only in a closed position, but also in a locked position.

FIG. 24 illustrates an enlarged top perspective view of lock 154 in a locked position. In FIG. 24, right-handed swing door 112 is in a closed position and left-handed swing door 114 is in an opened position for purposes of illustration. As illustrated, lower door catch 187 coupled to lower rail 168 is magnetically engaged with lower door stop 180 and therefore right-handed swing door 112 is in a closed position. However, magnet 182a is free and therefore lower catch 186 (not illustrated) is not magnetically engage with lower door stop 180 and left-handed swing door 114 is in an opened position. In FIG. 24, latch 176 has been rotated 90 degrees and is located inside the channel opening of U-shaped lower door catch 187. Right-handed swing door 112 is not only in a closed position, but also in a locked position.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A retail display unit comprising:
a top;
a base including a slot;
at least one swing door rotatably coupled to the top and the base and including a main panel and a lower rail engaged with a bottom of the main panel;
a door catch mounted to a back side of the lower rail and having a channel opening that faces downwardly at the base;
a latch rotatable through the slot in the base;
wherein when the at least one swing door is in a closed position, the latch is rotated through the slot in the base and positioned in the channel opening of the door catch to lock the at least one swing door.

2. The retail display unit of claim 1, further comprising a lower door stop mounted to the base and protruding upwardly from the base, the lower door stop including at least one magnet for magnetically coupling to a backward facing surface of the lower door catch when the at least one swing door is in the closed position.

3. The retail display unit of claim 1, wherein the at least one swing door includes an upper rail engaged with a top of the main panel and an upper door catch coupled to a back side of the upper rail and having a backward facing surface.

4. The retail display unit of claim 3, further comprising an upper door stop mounted to the top and protruding downwardly from the top, the upper door stop including at least one magnet for magnetically coupling to the backward facing surface of the upper door catch when the at least one swing door is in the closed position.

5. The retail display unit of claim 1, further comprising an adjustment mechanism coupled to an upper hinge of the at least one swing door, the adjustment mechanism configured to level the at least one swing door.

6. The retail display unit of claim 5, wherein the adjustment mechanism comprises an adjustment knob and an adjustment bracket coupled to the adjustment knob and the upper hinge of the least one swing door, the adjustment knob is configured to move side-to-side along a head screw to level the swing door.

7. The retail display unit of claim 5, wherein the adjustment mechanism is accessed through an access panel located on a top surface of the top.

8. The retail display unit of claim 1, wherein the main panel of the at least one swing door comprises a transparent material.

9. A retail display unit comprising:
a top, a base, a back wall and right-handed and left-handed side panels, wherein the base includes a slot;
at least one swing door rotatably coupled to the top and the base and having a main panel and a lower rail engaged with a bottom of the main panel;
a lower door catch coupled to a back side of the lower rail and having a channel opening that faces downwardly at the base; and
a lock including a lock body and a rotatable latch, the lock body having a key hole configured to receive a key; and
wherein when the at least one swing door is in a closed position, the lock body is activated by the key to rotate the latch through the slot in the base and into the channel opening of the lower door catch.

10. The retail display unit of claim 9, wherein the at least one swing door comprises a left-handed swing door having a left-handed lower rail and a right-handed swing door having a right-handed lower rail, and wherein the door catch comprises a lower left-handed door catch coupled to a back side of the left-handed lower rail and a lower right-handed door catch coupled to a back side of the left-handed lower rail, the lower door catches having channel openings that face the base.

12. The retail display unit of claim 10, wherein when the left-handed swing door and the right-handed swing door are in the closed positions, the lock body is activated by the key to rotate the latch through the slot in the base and into the channel opening of the lower left-handed door catch and the channel opening of the lower right-handed door catch.

13. The retail display unit of claim 9, further comprising a lower door stop mounted to the base and protruding upwardly from the base, the lower door stop including at least one magnet for magnetically coupling to a backward facing surface of the lower door catch when the at least one swing door is in the closed position.

14. The retail display unit of claim 9, wherein the at least one swing door includes an upper rail engaged with a top of the main panel and an upper door catch coupled to a back side of the upper rail and having a backward facing surface.

15. The retail display unit of claim 14, further comprising an upper door stop mounted to the top and protruding downwardly from the top, the upper door stop including at least one magnet for magnetically coupling to the backward facing surface of the upper door catch when the at least one swing door is in the closed position.

16. The retail display unit of claim 9, further comprising an adjustment mechanism coupled to an upper hinge of the at least one swing door, the adjustment mechanism configured to level the at least one swing door.

17. The retail display unit of claim 16, wherein the adjustment mechanism comprises an adjustment knob that is configured to move side-to-side along a head screw coupled to the upper hinge of the at least one swing door to level the swing door.

18. A retail display unit comprising:
at least one swing door rotatably coupled to a top and a base of the retail display unit and configurable into a closed position, the swing door including a main panel and a lower rail engaged with a bottom of the main panel;
a lower door catch mounted to a back side of the lower rail and having a channel opening that faces downwardly at the base; and
a latch rotatable through a slot in the base and positioned into the channel opening of the lower door catch to configure the at least one swing door into a locked position.

19. The retail display unit of claim 18, further comprising an upper door catch mounted to a back side of an upper rail engaged with a top of the main panel of the at least one swing door.

20. The retail display unit of claim 19, further comprising:
a lower door stop having at least one magnet and being mounted to the base and protruding upwardly from the base; and
an upper door stop having at least one magnet and being mounted to the top and protruding downwardly from the top; and
wherein the lower door stop magnetically engages with a backward facing surface of the lower door catch and the upper door stop magnetically engages with a backward facing surface of the upper door catch when the at least one swing door is in the closed position.
